(19) United States
(12) Patent Application Publication
(10) Pub. No.: US 2002/0183982 A1
(43) Pub. Date: Dec. 5, 2002

(54) Design and estimating tools for the design of communication infrastructure in a structure

(76) Inventor: Thomas C. Rauscher, Henrietta, NY (US)

Correspondence Address: MERCHANT & GOULD P.C., P.O. Box 2903, Minneapolis, MN, 55402-0903, US

(21) Appl. No.: 09/817,775

(22) Filed: Mar. 26, 2001

(51) Int. Cl. G06F 17/50

(52) U.S. Cl. 703/1

(57) ABSTRACT

The invention is directed to an integrated tool that allows drawings, estimates and specifications to be generated for communication equipment that are consistent with industry standards. Information about products incorporated into a drawings are exported to estimating and specification tools that allow the generation of specifications and estimates based on those products.

### BACKGROUND OF THE INVENTION

Construction of a building or complex requires lots of planning, design and forethought. To make sure construction is performed in a standardized way, the Construction Specifications Institute (CSI), jointly with Construction Specifications Canada (CSC) developed a MasterFormat™. The MasterFormat™ is a master list of numbers and titles for organizing information about construction requirements, products and activities into a standard sequence. The MasterFormat™ was introduced in 1963. The MasterFormat™ includes a front end and sixteen divisions directed to everything from masonry to furnishings. Currently there is no division relating to the design of communications infrastructure to accommodate communication equipment in a structure. CSI also developed a SectionFormat™ and PageFormat™ that provide standard formats for organizing the sections and individual pages of a specification.

In the design and construction process, architects typically use the MasterFormat™ to organize the requirements for a new building or renovation. The architect is typically the lead design professional for a project. The design phase generally proceeds as follows. First, a customer identifies a need and hires a lead design professional to establish a project scope and budget. Typically this is an architect, but does not always need to be. The lead design professional then assembles a design team of engineers and consultants who work together to create a schematic design and estimate. Once the schematic design is reviewed, modified as required and approved, which includes making sure the design can be built within budget, the design team then begins detailed design efforts. The detailed design is typically reviewed at 50% and 90% along with a revised estimate. This review often includes individuals from the facilities' Operations and Maintenance group for a given facility.

The design team prepares the construction documents and the project is put out to bid. Addenda are issued as required to clarify the bid documents. Bids are received and a contract(s) is awarded to the successful bidder(s) and construction begins. It is typically at this time when it becomes obvious that communication technology has not been adequately addressed and now there may be no space or money in the budget for the required technology requirements. This results in design changes and change orders to the contracts and disruptions to the construction timelines and plans.

Eventually the project is completed and the contractors turn over the record copy drawings and manuals to the operations and maintenance department for the facility. As-built drawings usually arrive 3-6 months later as hard copy prints, if at all. Meanwhile, the communications technology systems managers wade through what they were given and often need to rework, enhance or otherwise modify the results. Thus, communication technology requirements are not currently being addressed adequately under the current CSI model.

Historically, the communications industry communicates in system specific Request for Proposals and hand sketches while the construction industry communicates with performance specifications and CAD drawings. Because of this, technology system(s) requirements end up being addressed late in the construction cycle, typically by the owner of a facility, on a system by system basis. In fact, technology planning often begins after the rest of the project has gone out to bid. This results in construction projects that go out to bid with little or no coordination for communications technology, other than a few outlet boxes, conduit stubs and an occasional note to “coordinate in field with owner”. This lack of planning results in little or no space allocated in the building for communication technology or any money in the capital budget for the required infrastructure and typically not much time left to resolve the issues.

Thus, it is desirable to establish an effective and comprehensive model that can be used to better plan, build and also manage communication technology infrastructures in a manner that is consistent with the established design and construction industry. It is also desirable to provide a system and method that can streamline the generation of drawings, estimates and specifications of communication infrastructure that us consistent with the established design and construction industry.

### SUMMARY OF THE INVENTION

According to a first aspect of the invention, there is provided a method for generating drawings, estimates and specifications for design of communication equipment in a structure. The method includes the steps of:

(a) searching a master database for a communication product using a utility application whereas the user can enter search terms;

(b) importing the product selected in step (a) to a drawing application;

(c) exporting information about the communication product specified in step (a) to an estimating tool program which allows an estimate based on the communication product specified in step (a) to be created; and

(d) exporting information about the communication product specified in step (a) to a specification tool program which allows specifications of the communication product specified in step (a) to be created.

According to a second aspect of a preferred embodiment of the present invention, there is provided a computer for generating drawings, estimates and specification for design of communication equipment in a structure. The computer includes (a) a drawing tool program for selecting communication equipment to be designed in a structure and generating drawings of the selected communication equipment located in the structure wherein the drawing tool has an application that can be launched to search for product located in a master database by search terms entered by a user; (b) an estimation tool program communicating with the drawing tool program wherein the estimation tool program generated an estimate for the communication equipment selected in step (a); (c) a specification tool program communicating with the drawing tool program for generating specification of the communication equipment selected in step (a); and (d) a processor for running the drawing tool program, the estimation tool program and specification tool program.

According to a third aspect of a preferred embodiment of the present invention, there is provided a system for generating drawings, estimates and specifications for design of communication equipment in a structure. The system includes a general purpose computing device; a computer program comprising one or more program modules executable by the computing device wherein the program module comprise a drawing tool module for selecting communication equipment from a master database using search terms to be designed in a structure and generating drawings of the selected communication equipment located in the structure; an estimating tool module communicating with the drawing tool module wherein the estimating tool module generates an estimate for the communication equipment selected using the drawing tool module; and a specification tool module communicating with the drawing tool module for generating specifications of the communication equipment selected using the drawing tool module.

According to a fourth aspect of a preferred embodiment of the present invention, there is provided a method for generating drawings for design of communication equipment in a structure. The method includes the steps of:

(a) providing a plurality of levels of technology-based drawings wherein each level represents a distinct level of detail of communication equipment;

(b) providing a utility application that allows a user to search a master databases for products using search terms; and

(c) responding to user interaction to place a product symbol selected by a user in a level selected by the user.

According to a fifth aspect of a preferred embodiment of the present invention, there is provided a method for testing communication equipment using a hand held tester. The method includes the steps of:

(a) specifying communication equipment for a structure using a drawing tool program;

(b) identifying each piece of communication equipment with a unique identification; and

(c) downloading the unique identification of step (b) to the hand-held tester.

According to a sixth aspect of a preferred embodiment of the present invention, there is provided a method for generating drawings, estimates and specifications for design of communication equipment in a structure. The method includes the steps of:

(a) searching a master database for a communication product using a utility application wherein a user enters search terms;

(b) selecting a product from the search conducted in step (a);

(c) inserting the product selected in step (b) in a computerized drawing;

(d) repeating steps (a)-(c) for as many products as needed; and

(e) comparing the products inserted in step (c) with a do not forget list.

According to a seventh aspect of a preferred embodiment of the present invention, there is provided a method for generating drawings of a communication infrastructure. The method includes the steps of:

(a) launching a drawing tool that designs floor plans;

(b) launching a CAD Tools that has access to all products saved in a master database;

(c) using the CAD Tools;

(d) selecting a product based on the search conducted in step (c); and

(e) transferring the product selected in step (d) to the floor plan.

### BRIEF DESCRIPTION OF THE DRAWINGS

FIG. 1 is a logical schematic of a system according to a preferred embodiment of the present invention.

FIGS. 2-72 are various screen shots displayed in a preferred embodiment of the present invention.

### DETAILED DESCRIPTION OF THE PRESENTLY PREFERRED EMBODIMENTS

The present invention can be used to organize a comprehensive set of performance specifications, estimates and series of Technology drawings that assist a designer or architect incorporate communication infrastructure in a structure.

As already discussed, it is desirable that an architect incorporate communication technology requirements from the earliest stages of planning through the design and construction stages by including a Technology Engineer or Consultant in the process. In order for this to happen, Technology Engineers and Consultants must be able to prepare the project requirements including CAD Drawings, Performance Specifications and Estimates consistent with the existing CSI MasterFormat™, SectionFormat™ and PageFormat™ documents.

The Division 17 Organizational Model has been developed to effectively integrate the planning, estimating and design of inside and outside copper and fiber cable plants, data, voice, video and other low voltage systems. Division 17 effectively shows an organization to maximize the benefits of a common, facility-based infrastructure, establish meaningful budgets, allocate space and more effectively plan how technology is integrated into a construction project or existing facility.

This Division 17 Organizational Model and associated specifications are structured in the same manner as the existing CSI—Construction Specifications Institutions Divisions 1-16 MasterFormat™. The Division 17 model is a proposed addition to the CSI MasterFormat that ensures telecommunications systems are “designed into” a building during the design phase of the project versus the more traditional method of “retrofitting” the system into the building while it is being constructed. The major organizational sections of Division 17 are listed in Table 1.

TABLE 1
D17 Organizational Sections

| | |
|---|---|
| 17000 | Administrative |
| 17100 | Cable Plant |
| 17200 | Data Requirements |
| 17300 | Voice Systems |
| 17400 | Video/Audio Systems |
| 17500 | WAN Requirements |
| 17600 | Architectural, Electrical and Mechanical Systems |
| 17700 | Intra-Building Communication Systems |
| 17800 | Building Automation and Control |
| 17900 | Security, Access and Surveillance |

The present invention is directed to a system that provides a coordinated set of enhancements and templates for industry standard applications, including AutoCAD, Visio, Word and Excel that integrates the process of drawing, estimating and specifying communication infrastructure in formats that are consistent with standard methods used by design and construction industry.

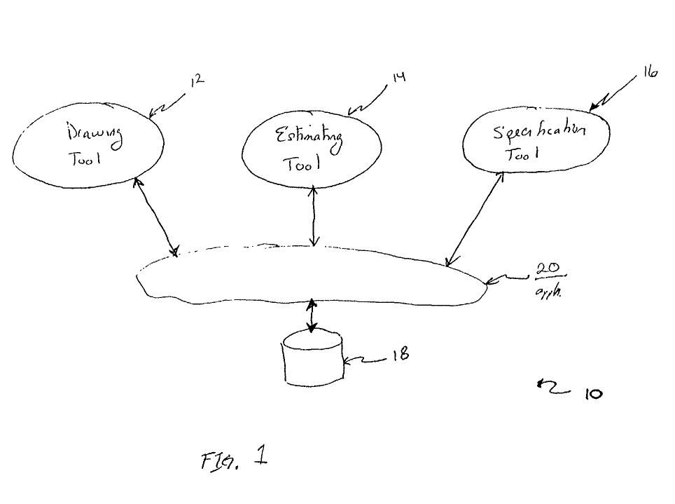

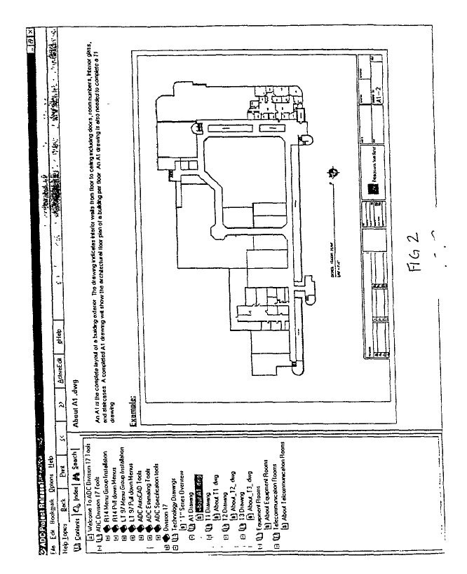

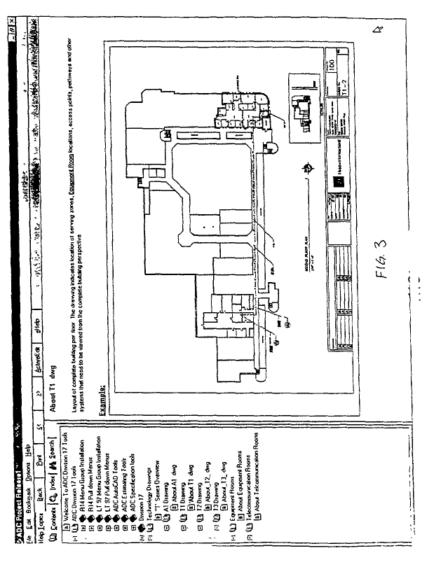

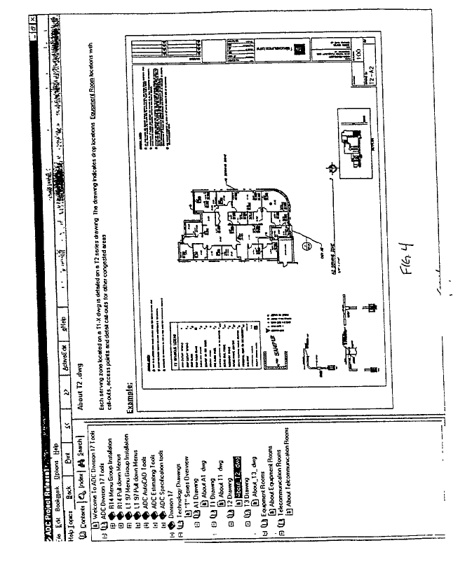

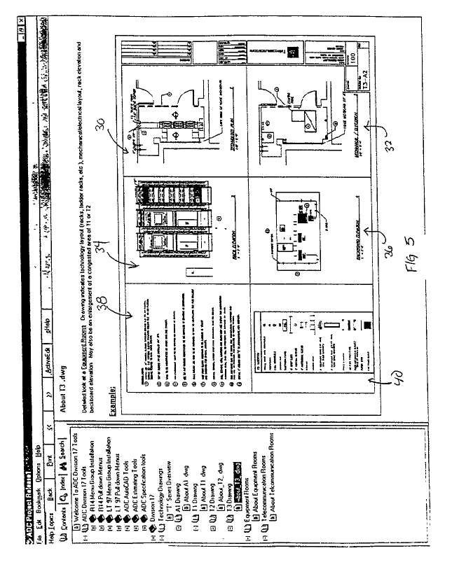

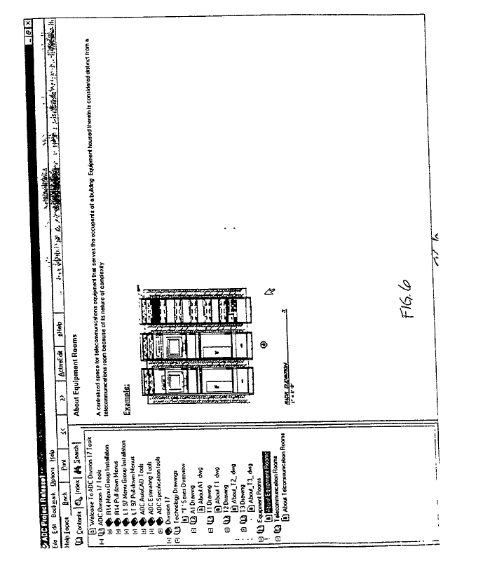

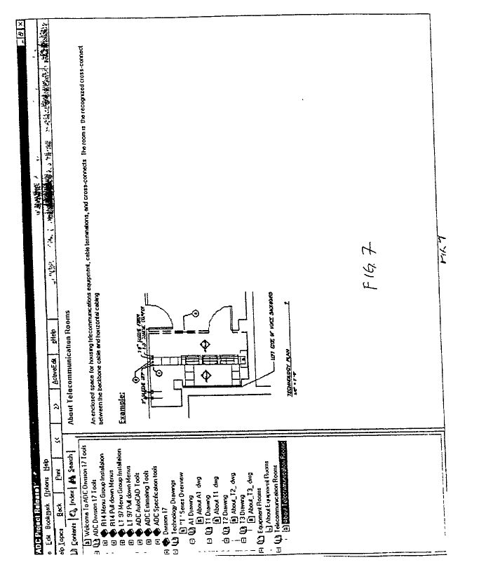

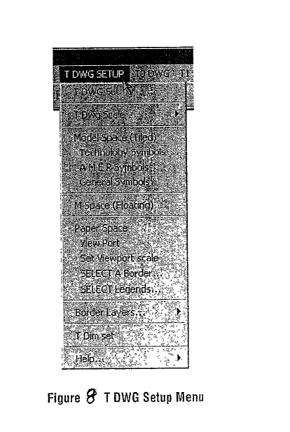

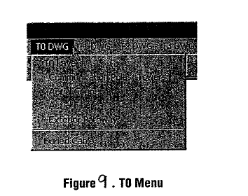

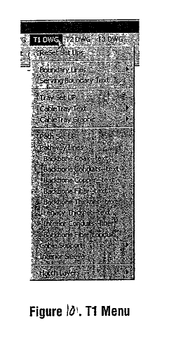

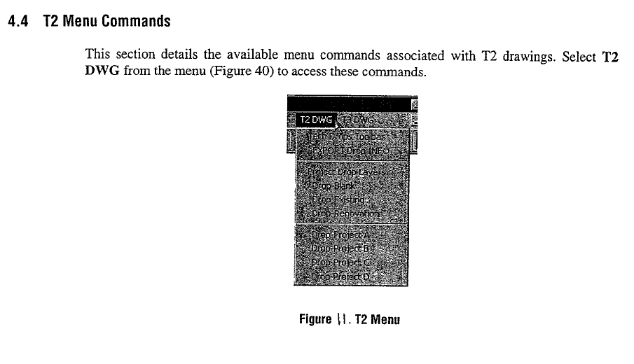

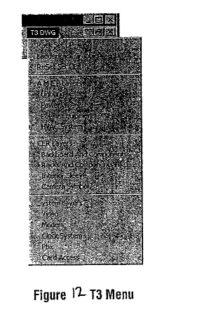

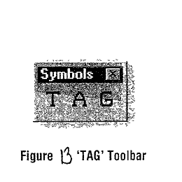

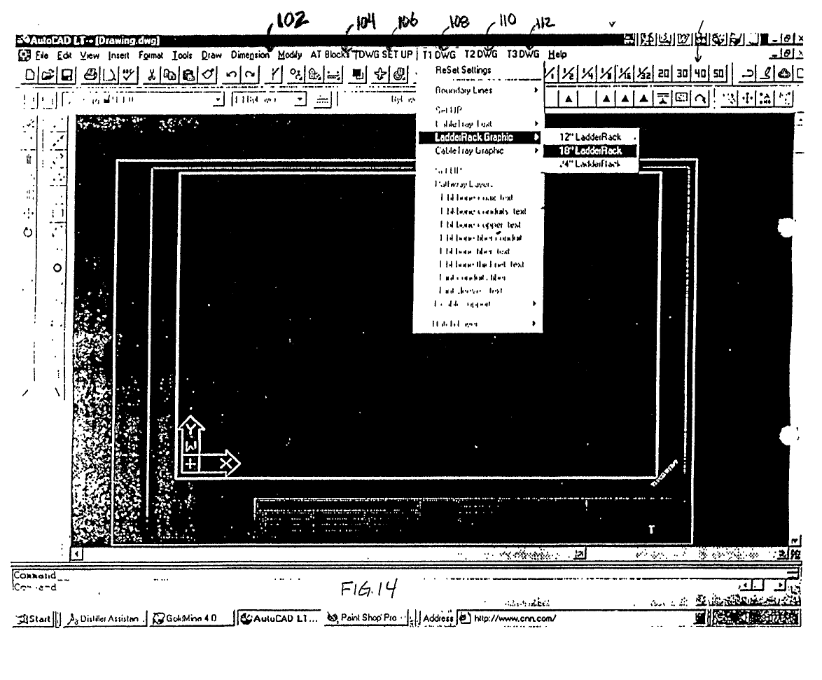

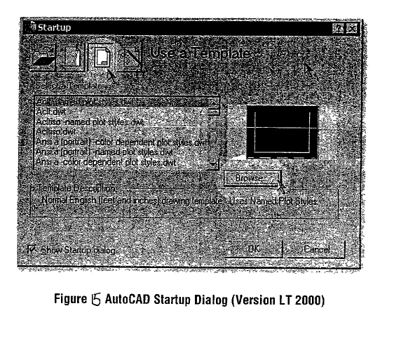

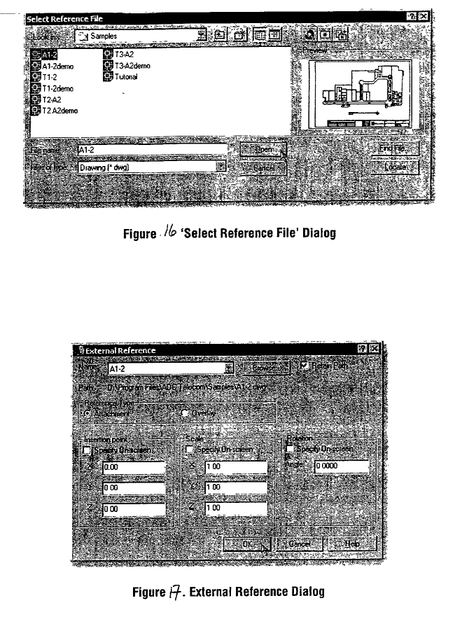

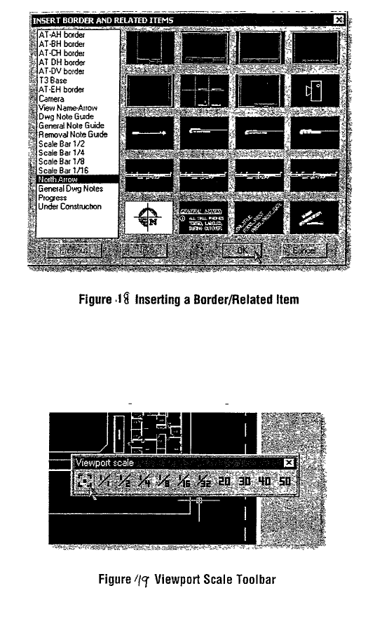

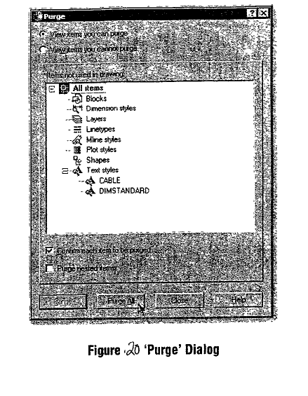

FIG. 1 is a logical schematic of the system 10 according to a preferred embodiment of the present invention. In a preferred embodiment the system 10 includes in tools, a drawing tool 12, an estimating tool 14 and a specification tool 16. The drawing tools include drawing templates, line styles, pre-drawn blocks and customized menus for various versions of AutoCAD and Visio as well as drawing set up procedures developed specifically for creating a detailed Technology (“T”) series of drawings. When the application is launched, a CAD Tool Template is selected with preset layering standards and title block. In addition, the menus are loaded with options grouped by drawing type which will be described in detail hereinafter. The CAD blocks are also grouped by drawing type, thereby reducing the chances of placing information on the wrong drawing. Detailed drawing setup procedures are included to ensure standardized drawing procedures. Quick scaling, drop detail and block information extraction tools are just a few of the automated processes that have been built into the menus and button bars.

The estimating tool effectively organizes a detailed estimate for the technology requirements during the design phases of a construction or renovation project. It allows for the presentation of project costs from a grand total sheet down to the specific manufacturer part numbers that have been used to develop the estimate.

The specification tools are a set of specifications organized in the Division 17 Model (see Table 1) for specifying the technology requirements in a construction project. The specification tools include editable templates that can be saved as project specification documents in Microsoft Word, for example. Portions of the document that require editing are highlighted and styles have been set to simplify editing and formatting. The specifications are organized to allow for use in industry standard format defined by the CSI SectionFormat™ and PageFormat™ documents. Project specification reports from the Division 17 tool will then be integrated with these master specification formats.

The tools 12, 14, 16 are software programs that provide certain functionality. The tools are preferably linked via a common master database 18 which will be described in detail hereinafter. The tools 12, 14, 16 communicate with the database 18 through an application 20. The tools 12, 14,16 may be software resident on a personal computer (not shown) and database 18 may be stored in a memory of the personal computer. Those skilled in the software arts will appreciate that various configurations are possible depending upon the degree of integration necessary. The database 18 stores product information organized by product ID, manufacturer, description, manufacturer description, part number, category, pricing information as well as any other information needed. Of course those of ordinary skill in the art will appreciate that other information can be stored.

In a preferred embodiment of the present invention, the drawing tool 12 is an enhancement of existing drawing software such as AutoCAD or Visio, for example, and, more preferably, the drawing tool 12 is an enhancement of AutoCAD® 14, AutoCAD® LT 98, AutoCAD®LT 2000, which will all be generally referred to hereinafter as AutoCAD®.

The drawing tool 12 includes customized AutoCAD® menus, technology specific line styles and blocks, as well as drawing setup procedures and templates as will be described in detail hereinafter. The estimating tool 14 preferably includes a master price table linked to vendor web sites for pricing updates and product information. The estimating tool 14 enables the preparation of detailed cost estimates based on standard categories as will be described in detail hereinafter. It may be linked to vendor's website so that updates may be added. Detailed cost estimates can be generated on an individual building basis and as a total project. The specification tool 16 produces documents that fit into industry standard CSI, 3 Part format.

Turning to a more detailed description of the various components of the present invention, the drawing tool 12 as previously described includes drawing templates, line styles, pre-drawn blocks and customized menus preferably for AutoCAD14® and AutoCAD LT® software packages although other drawing software may be used. AutoCAD® has been enhanced to allow a user to create detailed Technology (“T”) series of drawings, i.e., drawing that show the communication infrastructure. Briefly, when the drawing tool 12 is launched, an AutoCAD® Tool Template is selected with preset layering standards and title block. To further simplify the process, detailed drawing set up procedures are included to ensure standardized drawing procedures. Quick scaling, drop detail and block information extraction tools are just a few of the automatic processes that have been built into the menus and button bars of AutoCAD® as will be described in detail hereinafter.

The estimating tool 14 effectively organizes detailed reports of an estimate for the technology requirements during the design phases of a construction or renovation project according to various criteria as will be described hereinafter. The drawings created using the drawing tool are exported to the estimating tool as text files and information in the T drawings is linked to appropriate information in the database which is extracted by the estimating tool to generate various reports. More particularly, as products are added to a drawing, each product has a unique product identification code. When the drawing is exported to the estimating tool as a text file, the unique product identification code links the product in the drawing to information stored in the database which can then be extracted by the estimating tool. Thus, information concerning price, manufacturer and other relevant information is retrieved from the database and used by the estimating tool to generate a report.

The specification tool 16 produces documents/reports that are a set of specifications specifying the technology requirements in a construction project. Like the estimating tool, the specification tool generates specifications based upon the products selected in the drawings. The drawings created using the drawing tool are exported to the specification tool as text files and information in the T drawings is linked to appropriate fields in the specification tool. In a preferred embodiment, Microsoft's Word program is used. More particularly, the database stores specifications for each product that can be selected using the drawing tool. When the drawing is exported to the specification tool as a text file, the unique product identification code links the product with a specification for that product stored in the database. Thus, specifications can be generated for each product selected. The specifications are intended to serve as the foundation of a project specification. Portions of the document that require editing are highlighted and styles have been set to simplify editing and formatting. The specifications are organized to allow for use in industry standard format defined by the CSI SectionFormat™ and PageFormat™ documents.

The specification tools include the following templates:

Front End Cover Page, Bid Forms, Instructions, Agreement, Conditions, etc.

17000 Project Overview

17010 Basic Requirements

17030 Administrative Requirements

17050 Site Specific Requirements

17110 Communication Equipment Rooms

17120 Service Entrances, BDF's Main Closets

17130 Interior Pathways

17140 Exterior Pathways

17150 Backbone Requirements

17160 Horizontal Requirements

17170 Test, Administration and Documentation

17180 Cutover and Training

17190 Support and Warranty

Project specific specification reports are then integrated with these master specifications.

Thus, the present invention enables engineers, consultants and contractors to decrease the costs and time associated with designing technology infrastructures for new and existing buildings. The software tools integrate the process of estimating, drawing and specifying using a construction standard organizational model. The specification tools 16 allows engineers, consultants and contractors to get ahead of the curve quickly and easily with this comprehensive set of customizable documents organized by standard categories. The specification tool provides a customizable CSI-compliant project manual with three-part, preformatted specifications. Manufacturer-specific specs can even be cut and pasted into a proposal.

The drawing tool 12 allows engineers, consultants and contractors to improve drawing efficiency and standardize ‘T’ Series drawings within minutes of downloading this set of powerful, integrated tools. These CAD tools allow a user to customize AutoCAD 14® or AutoCAD LT® menus with technology-specific line styles, blocks and drawing-setup procedures. These integrated, flexible CAD tools work seamlessly with existing AutoCAD software.

Advantages associated with the present invention are a decrease in turnaround times associated with the development of specifications, estimates, and drawings; an increase in productivity and efficiencies using modular, integrated tools that can be easily customized to meet specific project or organizational needs; improved communications between all project team members including technology, communications and construction personnel.

I. Creating Drawings

Now a detailed description of a typical use of the system 10 will be described. First, during the design phase, drawings need to be created that specify the communication technology needs of a structure, whether it be a new construction or renovation. The drawing tools 12 allow communication technology drawings to be created in a standardized format with other drawings such as plumbing, mechanical and electrical. The drawing tool 12 is software that, in a preferred embodiment, extends AutoCAD® to applications of communication technology. As will be seen with a detailed description of the use of the drawing tool 12, an engineer, contractor or consultant can very easily and quickly create communication specific drawings, i.e., “T” drawings.

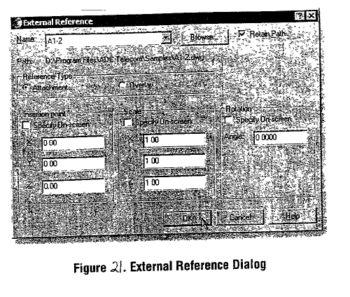

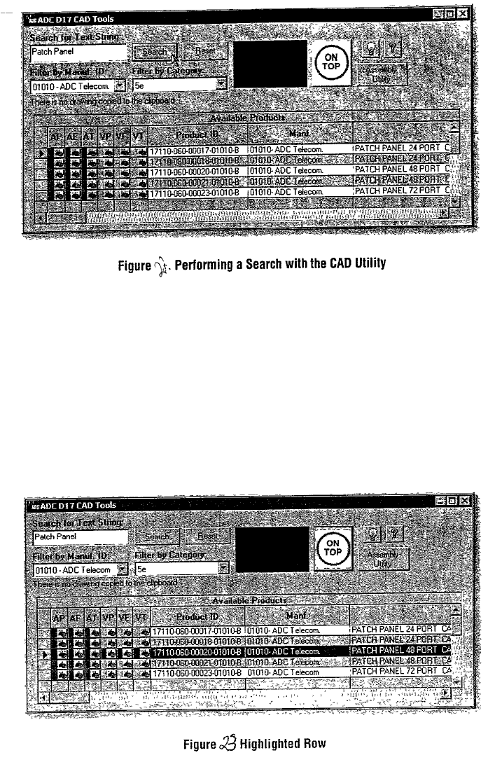

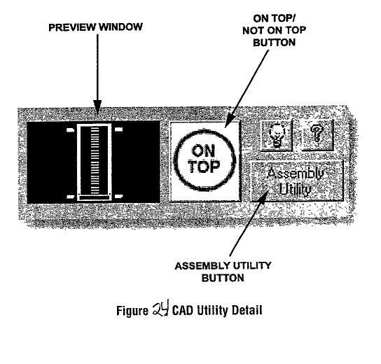

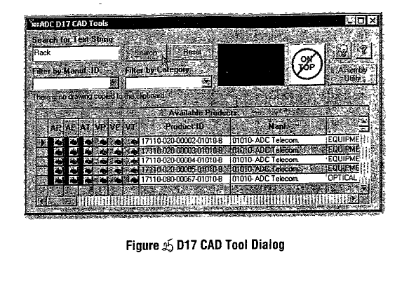

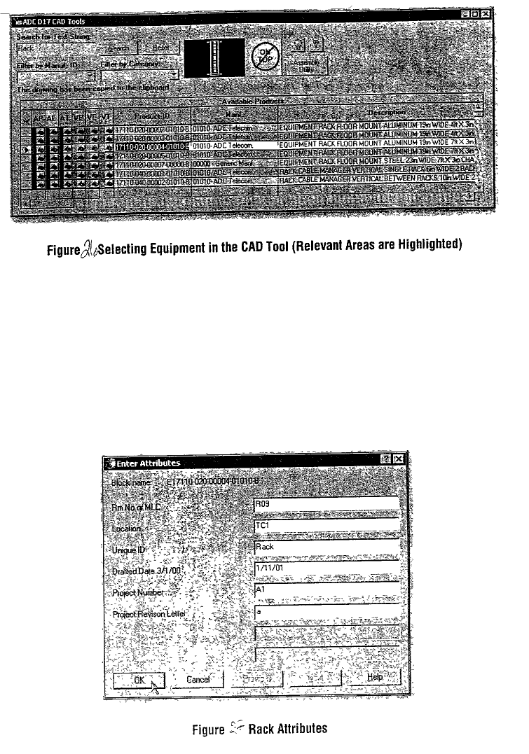

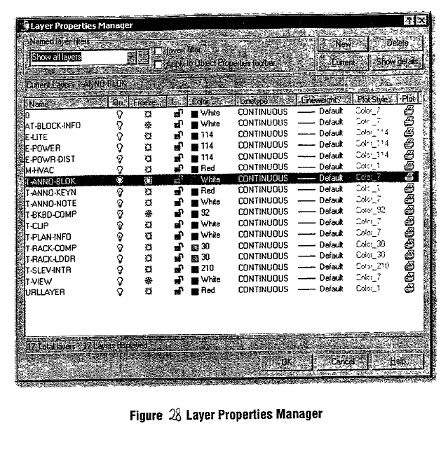

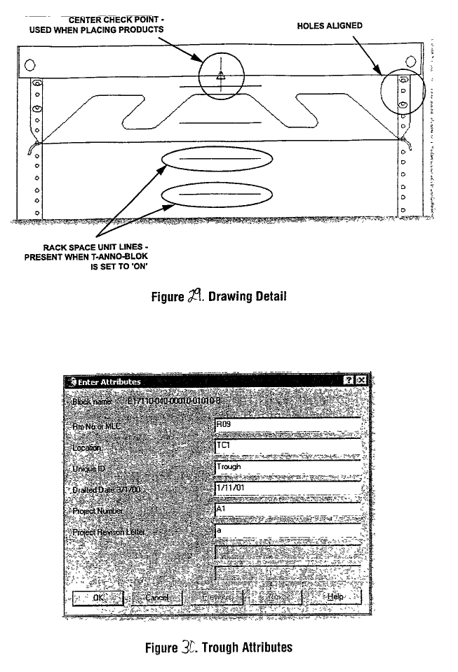

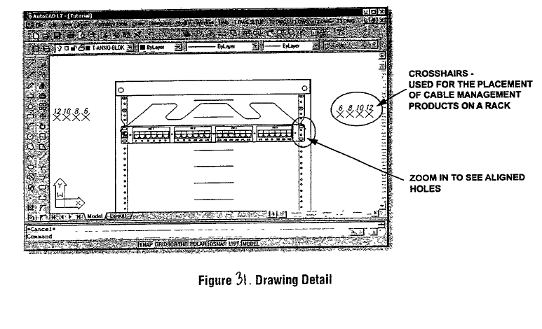

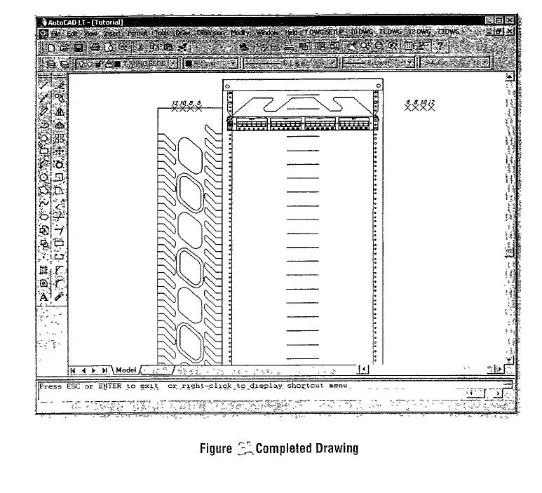

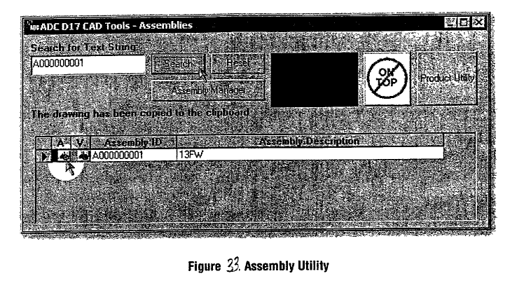

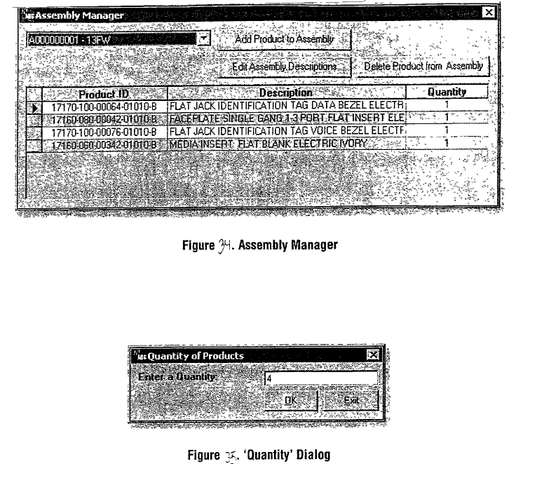

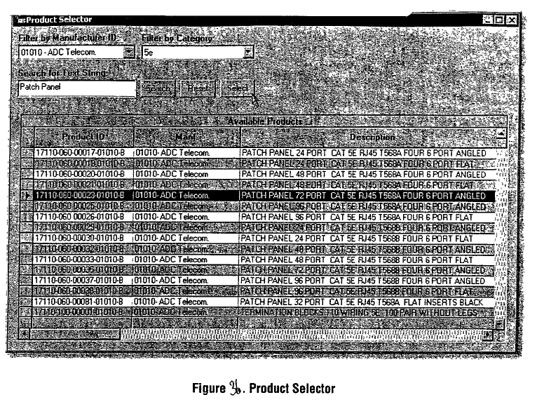

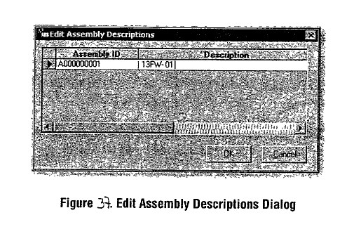

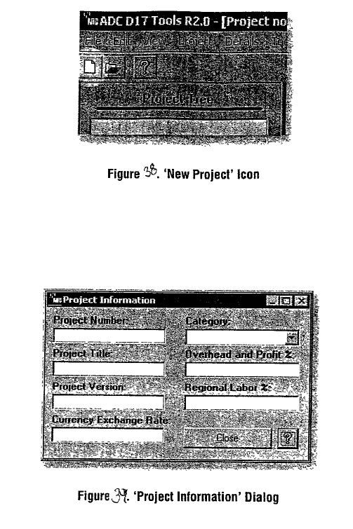

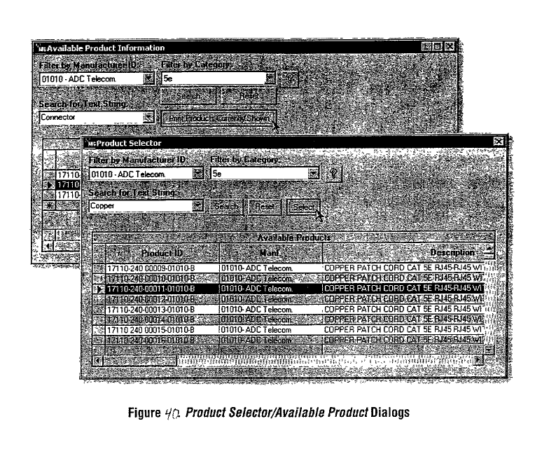

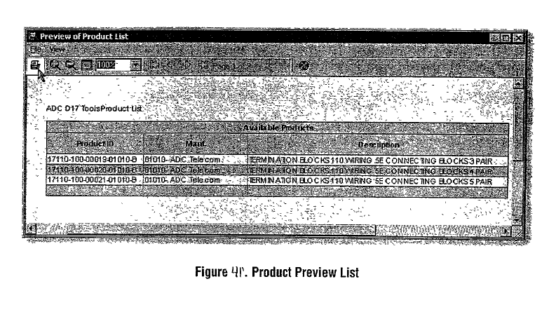

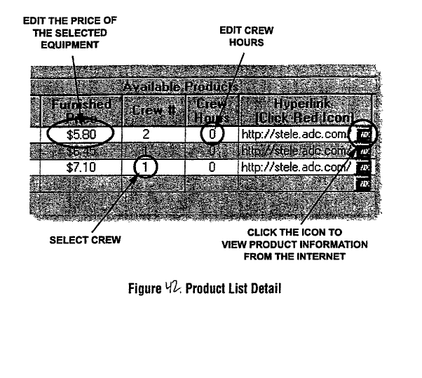

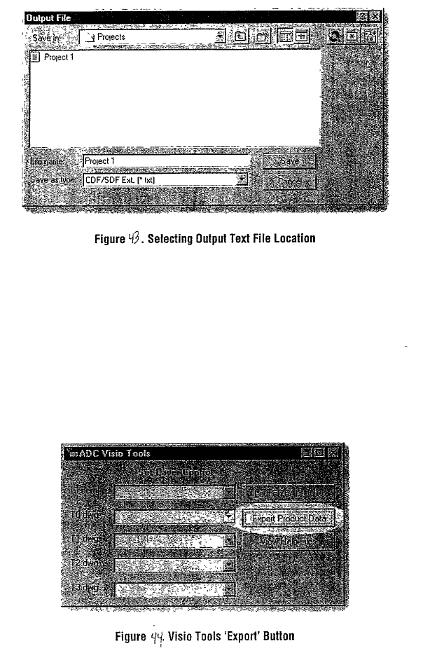

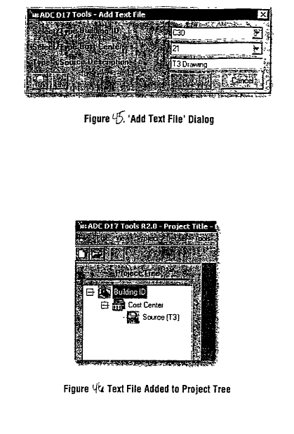

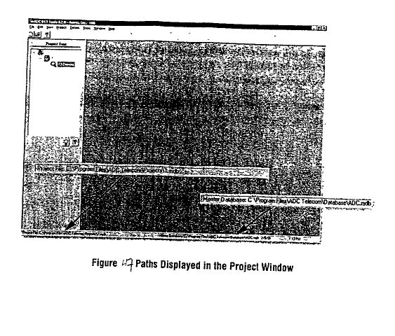

Perhaps the easiest way to describe the drawing tool 12 is to give a particular example. Drawings for a construction project are typically prepared using AutoCAD® or some other drawing software. An A1 drawing is the complete layout of a building exterior such as shown in FIG. 2. The drawing indicates interior walls from floor to ceiling including doors, room numbers, interior glass and staircases. A completed A1 drawing shows the architectural floor plan of a building per floor and is well known to those of ordinary skill in the art and this need not be described in further detail. An A1 drawing is needed to complete the technology drawings.

With the present invention, technology-based drawings can now also be drawn. In a preferred embodiment, either AutoCAD LT97 or AutoCAD R14 are used although other drawing packages may be used such as VISIO, for example. Technology, or “T” drawings are used to plan and communicate the technology requirements of the project with clients and other design professionals. The creation of accurate “T” Drawings require accurate base files or floor plans (A1 drawings) that are provided by an architect or other design professional. A list of “T” drawing types appears in Table 2.

TABLE 2
“T” Drawings

| | |
|---|---|
| T0 | Campus or Site Plans-Exterior Pathways and Inter-Building |
| | Backbones |
| T1 | Layout of complete buildings per floor-Serving Zone Boundaries, |
| | Backbone Systems, and Horizontal Pathways |
| T2 | Serving Zones Drawings-Drop Locations and Cable ID's |
| T3 | Communications Equipment Rooms-Plan Views-Tech and AMEP/ |
| | Elevations-Racks and Walls Elevations |
| T4 | Detailed drawings of symbols and typical such as faceplate labeling, |
| | faceplate types, installation procedures, detail racking, and raceways. |
| T5 | Schedules (Cabling and Equipment Spreadsheets) for cutovers |

The first level of technology-based drawings is a T1 drawing such as that shown in FIG. 3. A T1 drawing is a layout of a complete building per floor. The drawing indicates the location of serving zones, equipment room locations, access points, pathways and other systems that need to be viewed from the complete building perspective. The next level of drawing is the T2 drawing such as that shown in FIG. 4. The T2 drawing shows each serving zone located on a T1 drawing. The drawing indicates drop locations, equipment room locations with call-outs, access points and detail call-outs for other congested areas. The third technology-based drawing is the T3 drawing such as that shown in FIG. 5. The T3 drawing is a detailed look at equipment rooms. The T3 drawing indicates technology layout (racks, ladder racks, etc.) 30, mechanical/electrical layout 32, rack elevation 34, backboard elevation 36, drawing notes 38 and legend 40. As can be seen, a T3 drawing may also be an enlargement of a congested area of T1 or T2 drawing.

In addition to the technology-based drawings such as those shown in FIGS. 3-5, equipment and communication room drawings such as that shown in FIGS. 6 and 7 are provided. The telecommunication room drawing, FIG. 7, shows an enclosed space for housing communications equipment, cable terminations and cross-connects. This room is the recognized cross-connect between the backbone cable and horizontal cabling. The equipment room is a centralized space for communications equipment that serves the occupants of a building. Equipment housed therein is generally considered distinct from a telecommunications room because of its level of complexity. Thus, the present invention enhances existing drawing programs such as AutoCAD® to support technology-based drawings.

FIG. 14 is a screen shot of the launched drawing tool according to a preferred embodiment of the present invention. Various menu and tool bars are presented. A main menu bar 102 has existing AutoCAD menu items plus enhanced menu items 104-112 that have been added to allow the creation of technology drawings. Part of the enhanced menu is the addition of TN DWGS where N refers to numbers, i.e., T0, T1, T2, T3, T4, T5.

The Menu Commands of tool bar 102 will now be described in greater detail. First, the TDWG SETUP pull-down menu 106 will be described as shown in FIG. 8. Those of ordinary skill in this art will have a good working knowledge of AutoCAD™ and the detailed description herein assumes such a working knowledge. The options available under the TDWG SETUP pull-down menu are as follows:

T DWG Set

Runs AutoCAD XX or ADC-Menu_XX.mnl or ADC-Menu_XX.mnl command called “TDWGSET” which sets the variables “cmdecho” “orthomode” “attdia” “attreq” “UCS icon” “Dwg units” “snap” “coords” “ltscale” “psltscale” and “mirrtext”.

Creates text styles “CABLE” “DIMSTANDARD” and “STANDARD”

T Dwg Scale

Runs AutoCAD XX or ADC-Menu_XX.mnl command for each scaling factor and sets “LTSCALE” “DIMSCALE” “psltscale” and text style and size for the T drawings. In a preferred embodiment all “T” series drawing have the “LTSCALE” set to 192. The paperspace viewport should be scaled to this setting. For example:

⅛ inch=1 foot, therefore the viewport scale should be 1/96XP (96 times ⅛ equals 1 foot).

Export Block Info

Uses the command “attext” using “droptext.txt” file as a template. Creates a comma delimitated text file with the same name as the drawing file for importing into a spreadsheet.

Model Space (Tiled)

Same command as found under the VIEW pop on the menu bar.

M Space (Floating)

Same command as found under the VIEW pop on the menu bar.

Paper Space

Same command as found under the VIEW pop on the menu bar.

View Port

Only active in Paper space. Sets layer “T-view” and opens toolbar “VIEWPORT SCALE” and runs the command “mview”.

Set Viewport Scale

Only active in Paper space. Opens toolbar “VIEWPORT SCALE” and sets the screen to M Space (Floating).

Border Layers

Runs AutoCAD XX or ADC-Menu_XX.mnl command called “DWGLAYERS” and creates the following layers: T-anno-keyn, T-anno-note, and T-anno-symb. Each single layer name command creates only that layer and makes it current.

T Dim Set

Runs “TDWGDIM.SCR”, a script file that sets several dimension variables.

T0 drawings provide “campus view” site plans, including exterior pathways and inter-building backbones. These are high-level drawings based on the A1 drawing supplied by the designer/architect. The T0 DWG pull-down menu (FIG. 9) allows a user to add items such as communication poles/towers, aerial copper and fiber, exterior pathways, and buried cable to the exterior of the building as referenced from the A1 drawing.

T0 Layers

Runs ADC-Menu_XX.mnl command called “T0LAYERS” and creates the following layer: C-comm (utility and maintenance layer). Each single layer name command creates only that layer and makes it current.

Buried Cable

Loads linetype. Creates and sets layer, color, and linetype and makes it current. Starts the “line” command.

The T1 DWG pull-down menu (FIG. 10) allows a user to add features found in a T1 drawing.

ReSet Set Ups

Hides the Pathway and Boundary Lines toolbar.

Resets the default program setups by running the RESET command from ADC-Menu_XX.mnl. Resets the variables “cmdecho” “orthomode” “snapmode” and resets the commands “plinewid” “filletrad” “clayer” “celtscale” “celtype” and “snapunit”.

Boundary Lines

Select either Serving or Legacy boundary line.

Runs the command from ADC-Menu_XX.mnl to create/set layer, and load/set linetype from AT-Tech_XX.lin, sets “plinewid” and “filletrad”. Opens the “Pathway and Boundary Lines” toolbar and starts “pline” command. ADC-Tech_XX.lin, ADC-Ltype.shx, ADC-Tech_XX.mnl and AT-Ltype.shp should be located in “. . . /Program Files/AutoCAD XX/SUPPORT” for ease in locating these files for the line definitions.

Tray Set UP

Runs the SETRAY command from ADC-Menu_XX.mnl to set “cmdecho” “orthomode”, “plinewid” and “snap”. Checks for the layer “T-cabl-supp” and creates it if not found. Loads the linetype “CABLE_TRAY” from AT-Tech_XX.lin.

CableTray Text

Allows the user to select one of the listed “text” styles.

Runs the selected command from ADC-Menu_XX.mnl to load and set the linetype/starts the “pline” command.

CableTray Graphic

Runs the command from ADC-Menu_XX.mnl to set “celtscale”, “celtype”, and command “line”. Run “RESET set UPS” to cancel the settings made while drawing the various CableTray line style types.

Path Set UP

Runs the SETPATH command from ADC-Menu_XX.mnl to set variables, “cmdecho” “orthomode” “snapmode” and set commands “coords” “snapunit” “filletrad” and “plinewid.

Pathway Lines

Runs the ADC-Menu_XX.mnl command called T1LAYERS and creates T1 layers with appropriate line style and color. Each single line name loads the linetype.

Creates and sets layer, color, and linetype and makes it current.

Starts the “pline” command:

T-bkbn-coax-text

T-bkbn-cond-text

T-bkbn-cppr-text

T-bkbn-fibr-cond

T-bkbn-fibr-text

T-bkbn-thck

T-intr-cond-fibr

Cable Support

Ring Runs—Loads and sets linetype “RING_RUNG”. Creates and sets layer “T-cabl-supp” current. Starts the command “pline”.

Strands—Loads and sets linetype “STRAND”. Creates and sets layer “T-cabl-supp” current. Starts the command “pline”.

J Hook—Loads and sets linetype “J_HOOK”. Creates and sets layer “T-cabl-supp” current. Starts the command “pline”.

Interior Sleeve

Sets the “T-slev-intr” layer. The user may then place vertical or horizontal sleeves.

Hatch Layers

[T2Hatch-reno] Creates and sets current the layer “T-htch-reno”.

[Hatch-proj A] Creates and sets current the layer “T-htch-prjA”.

[Hatch-proj B] Creates and sets current the layer “T-htch-prjB”.

[Hatch-proj C] Creates and sets current the layer “T-htch-prjC”.

[Hatch-proj D] Creates and sets current the layer “T-htch-prjD”.

The T2 DWG pull-down menu (FIG. 11) allows a user to access commands associated with a T2 drawing such as.

Tech Drops Toolbar

Displays the “Technology Drops” toolbar.

Export Drop Info

Project Drop Layers

Drop-Blank

Runs command from ADC-Menu_XX.ml “BLANK” which sets layer “T-drop-blink”, sets “orthomode”, “osmode”, “snap”, and inserts SSymT-0050.dwg block scaled up by the “dimscale”.

Drop-Existing

Same as Drop-Blank with layer name “T-drop-exst”.

Drop Renovation

Same as Drop-Blank with layer name “T-drop-reno”.

Drop-Project A

Same as Drop-Blank with layer name “T-drop-prjA”.

Drop-Project B

Same as Drop-Blank with layer name “T-drop-pjB”.

Drop-Project C

Same as Drop-Blank with layer name “T-drop-prjC”.

Drop-Project D

Same as Drop-Blank with layer name “T-drop-prjD”.

The T3 DWG pull-down menu (FIG. 12) allows a user to access commands associated with a T3 drawing.

Rack Set UP

Sets “orthomode” “snap” and creates and sets layer “T-rack-lddr” and makes it current.

Loads linetype “Ladder_rack” from “ADC-TECH_R14.lin”

LadderRack Graphic

Select one of the LadderRack graphic styles. Runs command from ADC-Menu_XX.mnl and sets “snap”, “celtscale” and the command “mline”. If the “mlne” style is not loaded, an AutoCAD dialog box will open and ask for the name of the file where it can be found. Use the file called ADC-Tech_R14.mln. Run “RESET set UP” to cancel out settings made while drawing the various ladder rack line style types.

ReSet Set Ups

Hides “Pathway and Boundary Lines” toolbar.

Runs command “RESET” from ADC-Menu_XX.mnl to reset variables, “cmdecho” “orthomode” “snapmode” and reset commands “plinewid” “filletrad” “clayer” “celtscale” “celtype” and “snapunit”.

A M E P Layers

Runs ADC-Menu_XX.mnl “MECHELEC” and creates each of the four layers in this group and sets “0” layer current.

CER Layers

Runs ADC-Menu_XX.mnl command “CERLAYERS” and creates each of the two layers in this group and sets “0” layer current.

Sys Layers

Runs ADC-Menu_XX.mnl command “SYSLAYERS” and creates each of the five layers in this group and sets “0” layer current. Each single layer name command creates only that layer and makes it current.

A TAG toolbar (where do the user find it?) (FIG. 13) allows the user to quickly place commonly-used symbols into CAD drawings.

The user can grab the TAG toolbar with the user mouse and place it alongside the other AutoCAD toolbars.

Use the TAG toolbar to insert:

Technology Symbols (T)

AMEP symbols (A)

General Symbols (G)

Next, a detailed description of the use of the drawing tools to generate technology-based drawings will be described. In a preferred embodiment, the present invention will be described using AutoCAD(V enhanced by a preferred embodiment of the present invention. FIG. 14 is a screen shot of the main page 100 presented by the drawing tool to the user. To create a T1 drawing, the user selects the T1 DWG on the menu bar and selects File→Open. The user is presented with a start up dialog (FIG. 15) that appears within the main screen 100 shown in FIG. 14. The user selects “Use a Template” button 202 and then clicks the Browse button and selects a template from a list of templates displayed in the “Select a Template” window. The user selects a T1 template to create a T1 drawing. The T1 template, as do all the other T drawings already has the correct border, title block, title attributes and all the connect layers with the corresponding colors and line types along with a view port thereby making it consistent with other architectural drawings. When the template is selected, the user clicks Open [where is this?] and the border is automatically inserted into the drawing at coordinate 0, 0, 0. The user then selects File→Save As from the menu bar. The user saves the drawing in the appropriate project folder as T1-X where “X” is the floor number. The user then clicks OK to continue. Note there is a preview pane 208 which allows the user to view the template before actually selecting it.

The next step is to insert an existing A1 drawing. From the main page 100 shown in FIG. 14, the user goes to MODELSPACE (not shown) by using the pull-down TDWG SET UP menu item 105, and clicks M SPACE (tiled) (not shown) or the user can select the Model lab (not shown) at the bottom of the drawing. The user than selects INSERT→EXTERNAL REFERENCE (not shown) from the menu. A select reference file dialog box FIG. 16 is presented and the user browses to the original A1 architectural drawing that corresponds to the T1 floor number and click the Open button. The External Reference Dialog (FIG. 17) then appears. The user makes sure the “Retain Path” box is checked, the “Attachment” radio button is selected and the “Rotation” box is unchecked. Additionally, the user ensures that both “Specify On-screen” boxes are unchecked so that the “A1 drawing” will insert at 0, 0, 0-scale 1. The user then selects View→Zoom→X Extent from the menu to view the entire building floor.

Next technology information needs to be added to the T1 drawing. The user selects the TLDWG menu item from the main menu bar 102 which pulls down the menu shown in FIG. 10. From this menu the user can add information concerning serving zone boundary lines and call-outs, communication equipment room call-outs, pathway information, i.e., sleeves, cable trays, conduits, etc., and backbone cable, i.e., fiber, copper, coax, etc.

Next a border is set up. From the T DWG SETUP pull-down, the user clicks Paperspace→Borders and/or Legends to insert any other relative blocks into the drawing (north symbol, scale bar, logos, legends, etc. (FIG. 18)

Next, the viewport needs to be scaled. The user selects the T DWG SETUP→Set Viewport Scale (FIG. 14) from the tool bar and chooses the scale preferred or alternatively, the user can select T DWG SETUP→VIEWPORT to launch the Viewport Scale tool bar as shown in FIG. 19 which provides several preset scales for quick viewing. Alternatively, a VIEWPORT SCALE toolbar is also available in the main menu bar shown in FIG. 14 to complete this task.

When scaling is complete, the user freezes off the viewport layer and purges the drawing to remove unused named objects, such as blocks or layers from the drawing. To do this, the user selects File→Drawing Utilities→Purge from the AutoCAD menu. A dialog box (FIG. 20) appears which allows the user to choose the items that should be purged. The user then Saves the drawing.

Next, a T2 drawing is created. As previously described, T2 drawings depict serving zones and indicate drop locations, communication equipment rooms with call-outs, access points, cable ID's, and detailed call-outs for other congested areas. Each serving zone located on a T1-X.dwg is detailed on a T2 series drawing. From the startup dialog box shown in FIG. 15, the user selects “Use a Template,” then in the “Select a Template” box the user selects the T2 template. When the template is selected the border is automatically inserted into the drawing at coordinates 0,0,0. The user then selects the pull-down FILE→SAVE-AS and saves the drawing as Tx-YX, “Y” being the serving zone and “X” being the floor number.

The user then needs to reference the “T1” drawing and does this by selecting TDWG SETUP→MODELSPACE (Tiled) from the menu. The user then selects INSERT→EXTERNAL REFERENCE from the menu. In the Select Reference File dialog box, the user browses to the T1-X.dwg that corresponds to the floor number of the current T2 drawing and clicks Open. The External Reference dialog (FIG. 21) appears. The Retain Path box should be checked, the Attachment radio button selected and the Rotation box should be unchecked. In addition, the Specify On-Screen boxes should be unchecked so that the “A1” drawing will insert a 0, 0, 0-scale factor=1. The user then selects View→Zoom→Extents from the menu to view the entire building floor plan.

Next a clip boundary needs to be created. It is recommended to create T2 and T3 drawings in AutoCAD®R14 because of its clipping feature. In AutoCAD® LT the user must move the PAPERSPACE and adjust the viewport accordingly. Because of this, all call outs should be placed in PAPERSPACE.

Next the user draws a POLYLINE on T-clip layer around the serving zone that corresponds to the drawing name. Making sure the polyline is closed, the user selects MODIFY→OBJECT→CLIP from the menu, selects the X-reference to clip, and hits return twice then types “S” for SELECT BOUNDARY and hits return. This will “clip out” everything except for the serving zone. The T-clip layer is then frozen using the Layer Properties Manager.

Now technology information can be added such as call-out boxes around a CER and call-out, general drawing notes and drop locations with attributes as will be described in detail hereinafter.

Then, borders and legends are set up in the same manner as discussed with reference to the T1 drawings. The remaining steps are the same as described with reference to the T1 drawing. Within the template on the T2 drawing, there are block attributes in the upper right corner of the title block called Automated Material List (AML)(not shown). The user can use these blocks to designate the length of cable for a project. To use the AML, the user edits the attributes and extracts the drawing to a *.txt file. The length of cable can now be imported into the Estimating Tool for cost reporting.

Finally the T3 drawing is created. The template is created in the same manner already described with reference to the T2 drawings. The T1 drawing is again referenced as described with respect to the creation of the T2 drawing as is the clip boundary.

II. Product Locator

Technology information is added such as, Racks, cable managers, FDCs, patch panels, etc., backboards, ground bars, lights, security panels, etc.; cable trays, ladder racks, sleeves, etc., and general call-outs, camera symbols, etc. using the CAD tool as will be described in detail hereinafter. The remaining steps of setting up the border, scaling the viewport and purging the drawing are the same as those described with reference to the T1 and T2 drawings.

The CAD tool displays all available products in the master database that have drawings or text associated with them. The user can search for, and insert information into the project and into drawings using this tool. Products can be filtered by manufacturer and by category, and the Search function can be used to filter products further. The user opens this utility by clicking the icon on the Windows desktop, via the Start menu, or by selecting Tools→Cad Utility from the main tool bar. FIG. 22 shows the utility displayed in the main screen. The user can search by text string, and filter the search by manufacturer and/or category, respectively.

FIG. 22 shows the results from the query: Patch Panel (Search for Text String), ADC Telecom (Manufacturer ID), 5e (Category). All products in the database that contain these attributes are displayed under “Available Products”. The user can click the Reset button to clear all filters and display all products within the master database.

To aid in identifying the product being selected, the user finds the product it wishes to use and clicks in the column at the far left of the CAD Tool dialog box (identified by an arrow). The entire row will be highlighted as seen in FIG. 23. Products can be inserted into an AutoCAD/Visio drawing by clicking one of the six buttons to the left of the Product ID. If the selected file-type exists, it is then copied to the clipboard and may be pasted into AutoCAD/Visio. A message will appear above the Available Products list stating that the item has been copied to the clipboard. The button descriptions are as follows:

| AutoCAD BUTTONS | VISIO BUTTONS | COPY VIEW |
|---|---|---|
| AP = AutoCAD Plan | VP = Visio Plan | Looking down from |
| | | above the product |
| AE = AutoCAD Elevation | VE = Visio Elevation | Looking at the |
| | | product from ground |
| | | level |
| AT = AutoCAD Text | VT = Visio Text | Manufacturer |
| | | description (text) |

The preview window displays an image (if available) of the selected product. The user pastes the product by right clicking and selecting Paste or by selecting Edit→Paste from the program's menu and pasting the product. After pasting into AutoCAD, the user left-clicks once using the mouse at the location the user wishes to place the equipment in the “T” drawing. The user strikes Enter three times on the keyboard until the Attributes dialog (not shown) appears. After entering the product attributes, the equipment will be pasted into the drawing.

The On Top/Not on Top button (FIG. 24) is used to keep the dialog box on top of an AutoCAD/Visio session so that when the user clicks anywhere other than in the CAD Utility dialog box, it does not disappear underneath any open programs on the desktop.

An example of locating products to incorporate into the TN drawings will now be given. Suppose a user needs a rack. The user types, “Rack” in the Search for Text String field of the CAD Tools and clicks the Search button (see FIG. 25). The user selects the AE (AutoCAD Elevation View) button that is associated with Equipment Rack Floor Mount Aluminum 19 in Wide 7 ft×3 in Channel Black Finish (Part # ADCRACKBLK73). A picture of the selected product is displayed. (See FIG. 26). Clicking the AE button (as well as any of the other five buttons) copies the selected equipment to the clipboard. Equipment is categorized by product ID, manufacturer, description, manufacturer description, part number, and category. Clicking on the column headings will arrange the displayed equipment in numerical/alphabetical order. For example, to arrange the listed equipment in numerical/alphabetical order by description, the user clicks on the Description column heading. The equipment is pasted into the AutoCAD Model Space by right clicking within the CAD program and selecting Paste or by Selecting Edit→Paste from the menu. After pasting, the user left-clicks the mouse a single time at the location the user wishes to place the equipment. Enter is struck three times on the keyboard until the Attributes box appears and the information is filled in accordingly. (FIG. 27)

The information entered in the attribute box gives the piece of equipment a unique identifier that is used by other parts of the tool (i.e. generating reports and testing). These attributes are also used to identify an item within the project tree. After the information is entered, the user clicks OK and ADCRACKBLK73 will be placed into the Model Space.

Next, the user selects Format→Layer from the menu to bring up the Layer Properties Manager. The T-ANNO-BLOK layer should be turned-on and unfrozen. (Both the light bulb and sun icons should appear as shown in FIG. 28) Turing on and unfreezing this layer causes rack space unit lines to appear. These lines help with the alignment of products placed in the rack. Next the user returns to the CAD Tool and searches for Trough in the text string. Rack Cable Manager Top Crossover Trough (Part # ADCCMTG02) is selected. The trough is placed on the rack right at the top using the procedure previously described for the rack. The midpoint triangle (FIG. 29) appears to indicate that the mounting holes in the trough and the holes in the rack are aligned. The user strikes Enter on the keyboard three times until the Attributes box appears as shown in FIG. 30. The user fills in the information accordingly. The user can zoom into the trough area of the rack and notice the alignment of the holes (FIG. 31).

The user then returns to the CAD Tool and searches for ADCPP245EA110. Select Patch Panel 24 Port CAT 5E RJ45 T568A Four 6 Port Angled Panels (Part # ADCPP245EA110) by clicking the AE button on the CAD Tool. The user places the patch panel on the rack right below the trough. The midpoint triangle will appear when the panel and rack are aligned. The user fills in the information accordingly. Finally, the user searches for a cable management product, namely, an ADCCMVIBS08 using the CAD Tool. The user selects a Rack Cable Manager Vertical 41 in High 8 in Wide With Slack Managers by clicking the AE button the CAD Tool. Notice the 4 crosshairs on both sides of the rack (FIG. 32). The equipment will be placed over the “8” crosshair. The user pastes the equipment into the drawing and moves from left to right until it aligns with correct crosshair on the left side of the rack. Save the drawing. The user drawing should look like FIG. 32. Once all of the products have been added, the CAD Tool can be closed.

III. Assembly Unit

Next, the assembly utility will be described. An assembly is a group of products that can be added to a drawing. Those assemblies can be used multiple times within the same project or in other projects as well. The Assembly Utility is used to search for, and insert an assembly drawing into the drawing tool, i.e. Auto CAD® or Visio™, for example. To launch the Assembly utility, the user clicks on the Assembly Utility button in the CAD utility (FIG. 24). To insert a drawing into the drawing tool, the user enters a text string in the Search for Text String box and clicks the Search button as shown in FIG. 33. As seen, an assembly ID was searched and appears in the search result box. The user then can select A for Auto CAD™ or V for Visio™ that appear to the left of the assembly ID, field. The assembly selected will be copied to the clipboard and a message will appear above the search result box stating that the item has been copied to the clipboard. If a display is available it will appear in the previous window. Similarly as described with reference to the CAD utility, if the user clicks the Reset button, all filters are cleared and the search result box displays all assemblies within the master database. The On Top/Not on Top button is used to keep the Assemblies dialog box on top of any open programs. The Assembly Manager button is selected to launch the Assembly Manager Utility which will be described in detail hereinafter. The Product Utility button is selected to return to the CAD utility.

The Assembly Manager, as seen in FIG. 34, allows the user to add or delete products from an assembly as well as edit assembly descriptions. When the Assembly Manager button (FIG. 33) is selected, the drop-down menu of FIG. 34 is displayed. The drop-down menu contains a list of all assemblies in the master database. The user selects the assembly that the user would like to change by double clicking on that assembly. As can be seen in FIG. 34, the user has the option of adding product to an assembly, deleting product from an assembly and editing assembly description. In this particular example the user selects to add product to the assembly selected. The Quantity dialog (FIG. 35) appears and the user can enter the number of products to add to the assembly. By clicking the OK button the quantity is increased.

Next, the Product Selector Dialog box as seen in FIG. 36 appears which allows the user to search for products by manufacturer, category, and text string. If the user enters a text string as shown and clicks the Search button, a product list is displayed in the available product box. The Reset button can be clicked to clear all filters and display all products in the master database. If the user clicks the Select button, the selected product is placed in the assembly and can be viewed in the Assembly Manager as seen in FIG. 33.

To delete a product from an assembly, the user simply selects the product's row in the Assembly Utility shown in FIG. 34 and selects the Delete Product from Assembly button.

To change an assembly description, the user selects an assembly from the drop-down list and selects the Edit Assembly Description button. The Edit Assembly Description dialog (FIG. 37) is displayed and the user double clicks on the assembly to be charged. The user then enters a new description in the Description field and clicks the OK button when finished.

IV. Creating a New Project

The following procedure is used to create a new project using a preferred embodiment of the present invention. The user opens a New Project via the File Tool bar (FIG. 38). A Select a Different Master Database dialog will appear (not shown) and the user selects No. The user will be prompted to name the New Project. Once the project has been named, project information dialog (FIG. 39) appears. The user enters the project number, project title and project version in the edit boxes. This information will be used within the heading of the reports. The Currency Exchange rate is used to generate estimates and reports based on a selected currency rate. A Category can be selected from the drop-down list to specify the project design category which can be compared to products selected in the project. The Overhead and Profit Percentage and Regional Labor Percentages are used to adjust the report totals.

The Product Selector and the Available Product dialogs (FIG. 40) are versatile tools that allow the user to:

a Filter products by manufacturer, category, and text string

View, print, and select all available products within the master database

View and adjust the furnished price of the equipment, the number of crew and number of hours required to install the product

Hyperlink to the equipment manufacturer for product information. Both dialogs share many functions, the main difference between the two is that the Product Selector is used to search for, and insert products into a project, whereas the Available Product dialog is used to display and print all products in the master database.

The search function is the same for both dialogs. The user filters the user search by Manufacturer ID and Category by selecting the parameters from the drop-down lists. If the parameters of the desired equipment are not known, the user selects View All from the lists and all products in the database will be displayed for that category. A product type can be selected from the Search for Text String drop-down list or entered as a text string in the box. When all parameters are selected, the user clicks the Search button. The dialog will return all products that match the search parameters. The Reset button clears all filters and all products in the master database are displayed. The products in these dialogs are categorized by product ID, manufacturer, description, etc. Clicking on the column headers will arrange the displayed products in numerical/alphabetical order. For example, to arrange the listed equipment in numerical/alphabetical order by description, click on the Description column heading. To aid in identifying the product being selected, find the product and click in the column at the far left of the CAD Tool dialog box (identified by an arrow). The entire row will be highlighted. In the Product Selector, click the Select button to place the product into the project. In the Available Products dialog, click the Print Products Currently Shown button and the Product Review List (FIG. 41) will pop-up. Click the print icon to print the displayed information.

The user can also change equipment information using the Available Products dialog. The user may edit the text in the Description, Manufacturer Description, Furnished Price, Crew Hours, and Hyperlink columns by placing the mouse cursor in the box, highlighting the existing text, then entering new test. (See FIG. 42). This information will be saved to the database and will “follow” the equipment throughout the project.

V. Exporting Drawings

To export a drawing to a text file which can be accessed by the estimation tool and the specification tool, a user selects DWG Setup→Export Block Info from the AutoCAD menu. The user will be prompted to place the output text file in a project folder. An output file dialog box (FIG. 43) is displayed. The text file is a representation of every product added to the drawing. The estimation tool and specification tool reads the text file to generate estimates, reports and specifications as will be described in detail hereinafter. The drawing text file is now ready to be added to a project. If Visio is being used, the user clicks the Export Product Data button from the Visio Tools dialog (as shown in FIG. 44). The Export utility will create a text file in the same directory as the drawing with the same file name plus the text extension (*.txt). This drawing file can then be added to a project.

Once the drawings have been created, there are still opportunities to add text files and products to a project. These added files, however, do not appear in the drawings.

VI. Adding a Text File to a Project

Next, the process of adding a text file to a project will be described. The following procedure is used to add either Drawing Text files or manually created text (*.txt) files to a project. The user launches the D17 Tools program and opens an existing project (or create a new one using the procedure detailed in Section IV). Select Project→Add Drawing Text File or Add Manually Created Text File from the menu. This command can also be performed by right clicking on the Project Tree and selecting Insert Projects→Add Drawing Text File or Add Manually Created Text File. The Add Text File dialog (FIG. 45) appears. The Building ID is selected either from the drop-down list or by typing it in. The Building ID is a unique number or word that will be used to identify the building in the Project Tree and aid in creating reports and estimates. Likewise, the Cost Center information can be selected from the drop-down list or manually entered in the edit box and will aid in creating reports and estimates. The Source Description identifies the source of the information being added to the project (T3 drawing, etc.). After clicking OK in the dialog box the user will be prompted to select a *.txt file. The user navigates to the location of the drawing text files and selects a file to add to the project. The file is imported and the Products are added to the Project. The imported file will appear in the Project Tree (FIG. 46). All of the products placed in the CAD drawing have now been added to the project. At this point, Estimates and Specifications may be produced as will be described in detail hereinafter. The user will notice that the path to the project file is given at the bottom of the program screen (FIG. 47) This path identifies the current project. The path to the master database, which contains all the project information, is also given.

VII. Adding a Product to a Project

The following procedure is used to add a product from the master database to a project. The user selects Project→Add Single Product from the menu. This command can also be performed right clicking on the Project Tree and selecting Insert Projects→Add a Single Product. The Product Selector dialog (FIG. 48) will appear. The user then goes to the Search for Text String box and selects a product type from the drop-down list or enters a text string in the box. The user can also filter the search by Manufacturer ID and Category. Once the parameters are entered and the user clicks Search, the dialog will return all products in the master database that match the search parameters. The user selects the desired product by clicking in the far-left column of the row in which the product resides. The row will be highlighted for easier identification and the user clicks the Select button. (FIG. 49). The Add Products to Current Project dialog (FIG. 50) will appear. The user types in, or selects the Building ID from the drop-down list. The product will be placed “into” the selected building in the Project Tree. Likewise, the Cost Center information can be selected from the drop-down list or manually entered in the edit box. The Source Description provides a unique description of the product being added to the project. Enter the number of pieces of equipment being added is selected in the Quantity edit box. The added equipment will be displayed in the Project Tree (FIG. 51). The user can edit the source description for all branches of the Project Tree by right clicking on the item, selecting Rename, and typing the new description. All items in the Project Tree can be deleted from the project by right-clicking on the item and selecting Delete. The user can move icons around the project tree by highlighting and dragging to different locations.

VIII. Products In Use Dialog

The Products in Use dialog (FIG. 52) a multi-functional tool that can be used to:

View all products within a project

Filter and display products by building, cost center, and product description

Adjust product quantities

Export data

Create reports and specifications

The dialog is accessed by double clicking on the icons within the Project Tree or by selecting Project→Edit Product Quantities from the menu. Double clicking on an icon in the Project Tree will display all products associated with that icon. For example, clicking on the icon for building C30 will display all products associated with building C30 in the dialog's Product Quantities list.

All products within the project will appear in the Product Quantities list when the dialog is opened. The list can be filtered to display only products that meet certain criteria. This is handy for finding equipment in a large project. The user can filter by any combination of Building ID, Cost Center, Source Description, and/or Text String. To filter by Building ID, Cost Center, or Source Description the user selects an item from each of the drop-down lists. As each parameter is selected the Product Quantities list will adjust accordingly. Only items that exist in the project will be contained in the drop-down lists. To filter by Text String, the user selects an existing text string from the drop-down list or by manually entering text into the edit box and clicking the Search button. All products in the project that match the filtering criteria will be displayed in the Product Quantities list as seen in FIG. 53. Click the Reset button to clear all filters and display all products within the project.

The quantity of any product in the Product Quantities list can be adjusted by simply highlighting the existing quantity (the pencil icon will appear, see FIG. 54) and typing the new quantity.

Various project data can be exported to files outside the D17 Tools program. Select one of the four Exporting options in the Export and Reporting Functions drop-down list (FIG. 55). The Exporting Product Data option exports the displayed product data to an ADC Project Tree (.txt) File. The Exporting Unique ID's option exports the unique ID data for the displayed products to an Unique ID Text (.udf) File. The Exporting Unique ID's, OLC, MLC option exports the unique ID, OLC, and MLC data for the displayed products to an Unique ID, OLC, MLC (.uom) Text File. The Exporting Product ID's option exports the product ID data for the displayed products to an Product ID Text (.pid) File.

IX. Adding Groups of Products

The present invention allows the user to create groups of products and add them to projects. Groups are bundles of products that once created, can be used on multiple projects. To create a group, select Details→Product Groups from the menu. Click the Create a Group button in the Product Groups dialog (FIG. 56). The Select a Group and Initial Product Quantity dialog will appear. To create a new group, type the group name in the Select/Type a Group edit box and enter the number of initial products (the number of units of the first product added to the group) in the Enter a Quantity edit box. The user will be prompted to select the initial product. The Product Selector dialog will appear. Search for a product to place in the new group, and use the Select button to add it (FIG. 57).

To delete a product from a group, select the group in which the product resides from the Select a Group drop-down list (FIG. 56). Highlight the product in the Products list then click the Delete Product from Group button. A confirmation dialog will appear.

To permanently delete a group from the project, select a group from the Select a Group drop-down list (FIG. 56), then click the Delete a Group button. A confirmation dialog will appear.

Existing groups can be added to different projects, buildings, cost centers, etc. Use the following procedure to add a group to a project the user selects.

Project→Add Group of Products from the menu. The Tools—Add a Group to a Project dialog (FIG. 58) appears the user selects an existing group to add to the project from the Select a Group to Insert drop-down list. Using the drop-down list, the user selects an existing entire row building with which to associate the group or type a new building ID into the Building ID edit box. Using the drop-down list, the user selects an existing cost center with which to associate the group or type a new building ID into the Cost Center edit box. A unique description of the group is entered into the Source Description edit box and the number of groups to add is entered in the Quantity of Groups edit box. The group will be added to the Project Tree under the specified building and cost center (FIG. 59). The user can move icons around the project tree by highlighting and dragging to different locations.

X. Labor Rates

The Labor Rates dialog (FIG. 60) is used to view/change labor rates and create crew types for the project. The user selects Details→View Labor Rates from the menu to open the dialog. Labor rates comprise the per-hour cost of a crew (one or more people used to install a specific product), the equipment cost per-hour, and any per-hour miscellaneous costs. The Modify Crew Costs list contains the crew number, description, labor rate, equipment cost, and miscellaneous costs for each crew in the project. Accurate labor rates are important for creating thorough project estimates, reports, and specifications. To enter the information, place the mouse cursor in the desired field (the pencil icon will appear in the far-left column) and type in the appropriate data for each category. This dialog may also be used to create new crew types. Again, place the mouse cursor in the desired field and enter the data for the new crew type. When the user enter information in the bottom line of the list, a new line will automatically be created for the addition of a new crew.

XI. Category Discounts

Category discounts may be applied to the project through the use of the Category Discounts dialog (FIG. 61). Select Details→Apply Category Discounts from the menu to access this dialog. A discount rate may be given for all Products within a specified range of products. For example, the manufacturer may give a 10% discount on all products that fall under Master Format category 17160. To enter this information in the dialog, simply place the mouse cursor in the Discount Rate % column for the selected category and type in the discount percentage. This information will be used in calculating estimates and in generating reports.

XII. Project Notes

The Project Notes window, as the name implies, is used to input miscellaneous, project-specific information. The dialog (FIG. 62) is a simple word-processing page (similar to Windows Notepad) into which text can be typed or pasted. Select Project→Edit Project Notes from the menu to access this tool.

XIII. Estimation Reports

The present invention allows the user to generate Estimation Reports based on the data contained within the project. The estimation tool is used to calculate project costs based on the contents of the project. These contents include imported equipment from drawings created in AutoCAD and Visio, equipment that was manually added using the Product Selector, labor costs, and category discounts. Estimation reports are generated from the Products in Use dialog using the Export and Report Functions drop-down list (FIG. 63) Once generated, the reports can be viewed in the Report Viewer. Each report will launch in its own viewer, from which it may be printed or exported. Exported files are placed in the project file with the .rpt suffix. Double click on a building or cost center icon in the Project Tree to launch the Products in Use dialog. If the user select a building, the report will include all subordinate cost centers. The user may select a specific cost center within the building by using the Filtering tool. Select the type of report the user would like to generate:

Building Detail Report without Labor

Building Summary Report without Labor

Building Detail Report with Labor

Building Summary Report with Labor

Building Detail Report without Pricing

Building Detail report contains detailed product information (product ID, part number, description, unit cost, quantity, and total cost) for every piece of equipment in the building. Building Summary reports summarize the building equipment by Master Format category. Individual pieces of equipment are not listed. The reports are broken-down by building (if selected), cost center, and sub-category.

XIV. Creating and Viewing Specifications

Specifications are compiled in the 3-Part CSI MasterFormat format and may be created for all 3-parts or for Parts 2 and 3 only. Specifications are generated from the Products in Use dialog using the Export and Report Functions drop-down list (FIG. 63). Double-click the item in the Project Tree to bring up the Products in Use dialog box. Click on the Export and Report Functions drop-down list and select the Specification to be created. The Specifications dialog (FIG. 64) will appear, allowing the user to specify a file prefix and location for the specifications. The files will all begin with the specified prefix. The user can then navigate to the files and open them. The file prefix the user specified is followed by the Division 17 category into which the products fall (FIG. 65). The specifications will open in Microsoft Word (if installed) and must be edited for the current project. (FIG. 66).

XV. Don't Forget List

The Don't Forget List is used to remind the user of products that are essential to most projects, but that are commonly overlooked. The user may add and delete products from this list at any time by selecting Tools →Modify ‘Don't Forget List’ from the menu. The Modify Don't Forget List (FIG. 67) will appear. To add a product to the list, click the Add Product button. The Product Selector dialog will appear as previously described to help the user find a product. Locate the product the user wish and click Select. The product will appear in the ‘Don't Forget’ List. To delete a product from the list, the user simply highlights the product by clicking on the far-left column and click the Delete Product button. This list is compared with the Products currently loaded into the project and a report may be generated to view a list of Products that have been forgotten. To generate this report, click the compare Project to ‘Don't Forget’ List button. A report viewer will appear listing all products in the ‘Don't Forget’ List that are not in the project.

The following tools are accessed from the Tools menu:

Compare Two Product List Text Files—This tool generates two reports showing Products that are in the Project but not in the selected Text File and vice versa. Performance Category Comparison Report—This tool generates a report that shows products in the project that do not match the specified performance category. View Duplicate Unique ID's—This tool generates a report that shows products with identical unique ID's that have the same Building ID and Cost Center. View Label Template—This tool generates window that displays label templates.

XVI. Wizards

A preferred embodiment of the present invention also allows Wizards to be created and used. A Wizard is a list of questions that are asked in association with a typical design scenario (i.e. “How many closets?”) which ensures that all necessary items or equipment are included in the project. The questions are used as a prompt or reminder to help the user complete the project.

To create a wizard, select Details→Estimation Wizards from the Tools menu. The Project Wizard dialog will appear. Click the Create Wizard button and the Create a New Wizard dialog will appear as shown in FIG. 68. A Wizard is created with a category. These categories contain questions that are answered by groups. In this example, a Wizard named School is being created. The question, “How many Closets?” is answered by six of the “Groupl” groups. This wizard is reminding the designer of typical closet information (product type and quantity). A wizard can contain multiple questions and multiple groups can answer those questions. To add a question, select a Wizard from the Select a Wizard drop-down list, then click the Add Question button. The Add Question to Wizard dialog (FIG. 69) will appear. Select the wizard to which the question will be added from the Wizard Name drop-down list. Enter the question in the Question edit box. Select the group from the Group Name drop-down list, and enter the quantity in the Quantity edit box. The user can also delete Wizard questions via the Wizard Manager. Select a question to delete from the Project Wizard Questions list, then click the Delete Question button. A confirmation box will appear.

To permanently delete a wizard, select it from the Select a Wizard drop-down list in the Project Wizard dialog (FIG. 70) then click the Delete Wizard button. A confirmation box will appear.

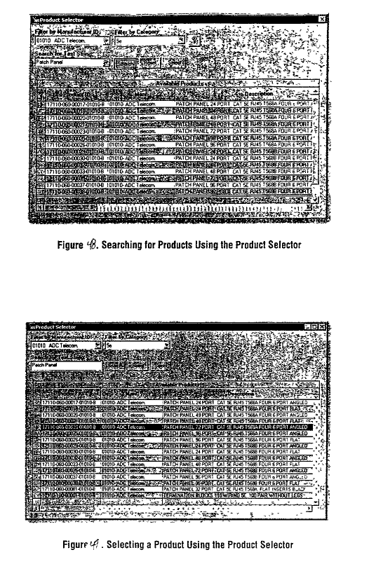

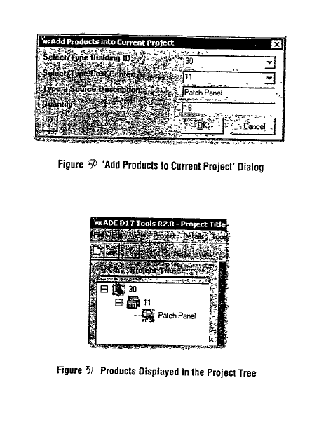

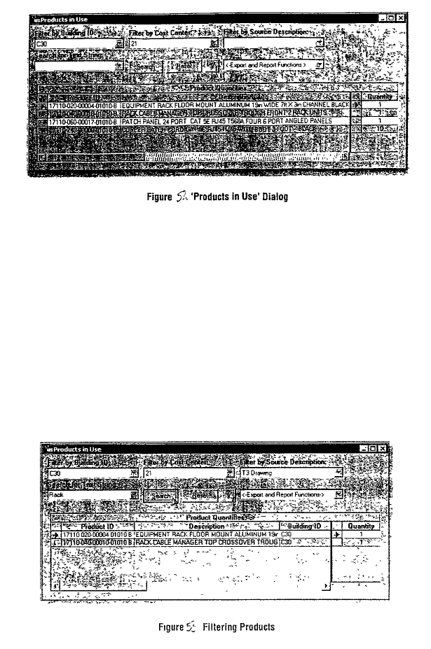

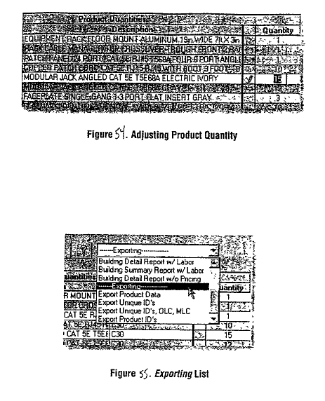

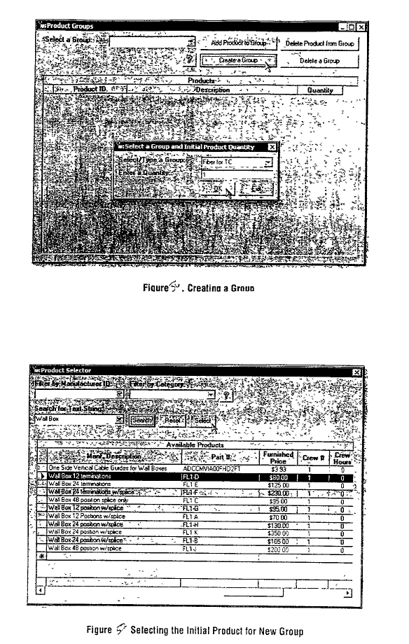

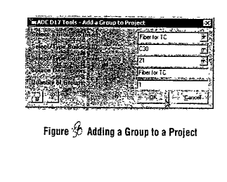

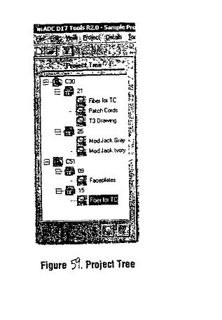

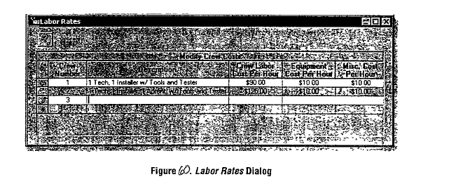

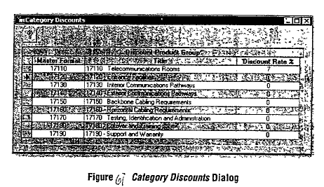

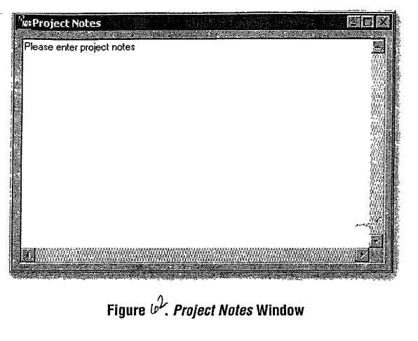

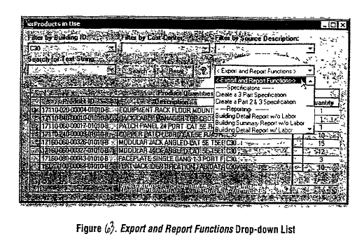

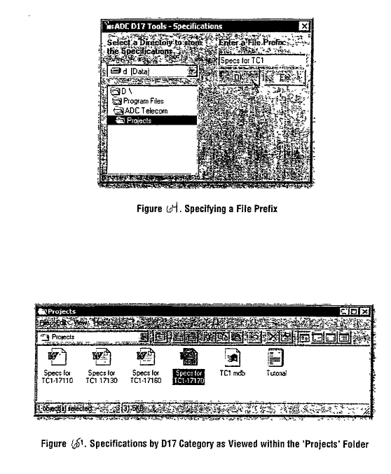

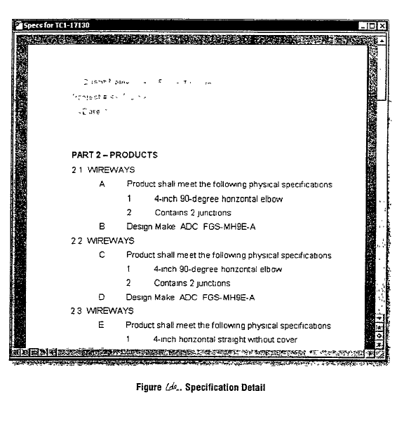

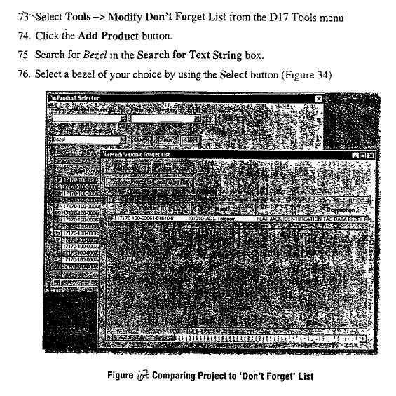

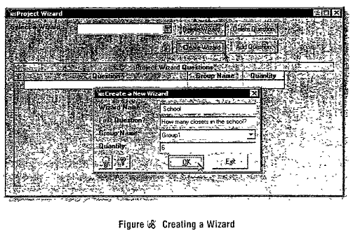

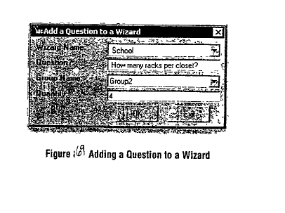

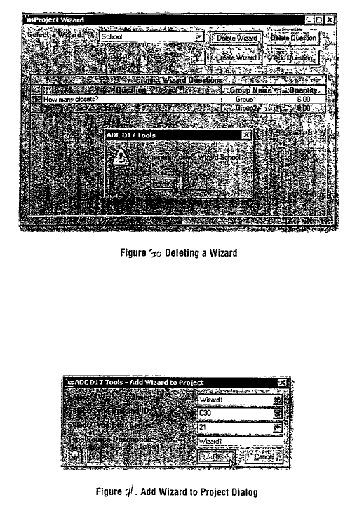

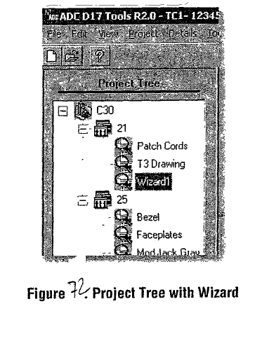

Adding Wizard Results to projects answer the questions for which the Wizard is created. To add a Project Wizard to the project, select Project→Add Project Wizard Results from the Tools menu, or right click in the project tree and select Insert Products→Add Project Wizard. The Add Project Wizard dialog (FIG. 71) will appear. Select an existing wizard from the Select a Wizard to Insert drop-down list, then select or type the building ID and cost center to which the wizard will be associated. Enter a unique source description in the Source Description edit box, then click OK. The wizard will be placed in the Project Tree under the specified building and cost center (FIG. 72). Double click on the wizard within the project tree to launch the Products in Use dialog, which displays all products within the wizard.

The estimates and specifications can be reported over any type of network such as LANs, WANs, Internet, Intranet, and inclusive or wireless and satellite transmissions.

XVII. Labeling

In a preferred embodiment, the tools of the present invention can be used to down load unique identifier labels to hand held testers. Consultants can now come up with a labeling for their clients which includes names, locations, cable, etc for each outlet. Previously this information had to be transferred to a labeling template so the labels could be run and placed on the faceplates and patch panels. By allowing the contractor to down load directly, the contractor saves time and the consultant has the labeling scheme that he or she wants.

This down load into the hand held tester also allows the contractor to test using the jack name rather than cross reference his or her testing numbers and jack labeling. As an example the contractor may have test results for locations 100-500. These test results would then be cross-referenced to the actual jack locations. (100=2101-A4) The download would allow the contractor to do the testing by the actual locations 2101-A4-2501-A4. This again is a time savings to the contractor and allows the designer the control of not only the labeling but the testing.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for generating drawings, estimates and specifications for design of communication equipment in a structure, the method comprising the steps of:
(a) searching a master database for a communication product using a utility application whereas the user can enter search terms;
(b) importing the product selected in step (a) to a drawing application;
(c) exporting information about the communication product specified in step (a) to an estimating tool program which allows an estimate based on the communication product specified in step (a) to be created; and
(d) exporting information about the communication product specified in step (a) to a specification tool program which allows specifications of the communication product specified in step (a) to be created.

2. The method of claim 1 further comprising a step of previewing a product after step (a) before it is imported in step (b).

3. A computer for generating drawings, estimates and specification for design of communication equipment in a structure, comprising:
(a) a drawing tool program for selecting communication equipment to be designed in a structure and generating drawings of the selected communication equipment located in the structure wherein the drawing tool has an application that can be launched to search for product located in a master database by search terms entered by a user;
(b) an estimation tool program communicating with the drawing tool program wherein the estimation tool program generated an estimate for the communication equipment selected in step (a);
(c) a specification tool program communicating with the drawing tool program for generating specification of the communication equipment selected in step (a); and
(d) a processor for running the drawing tool program, the estimation tool program and specification tool program.

4. A computer-readable medium having computer-executable instructions for the method recited in claim 1.

5. A computer data signal embodied in a carrier wave readable by a computing system and encoding a computer program of instructions for executing a computer program of instructions for executing a computer program performing the method recited in claim 1.

6. A system for generating drawings, estimates and specifications for design of communication equipment in a structure, the system comprising:
a general purpose computing device;
a computer program comprising one or more program modules executable by the computing device wherein the program module comprise a drawing tool module for selecting communication equipment from a master database using search terms to be designed in a structure and generating drawings of the selected communication equipment located in the structure;
an estimating tool module communicating with the drawing tool module wherein the estimating tool module generates an estimate for the communication equipment selected using the drawing tool module; and
a specification tool module communicating with the drawing tool module for generating specifications of the communication equipment selected using the drawing tool module.

7. A method for generating drawings for design of communication equipment in a structure, the method comprising the steps of:
(a) providing a plurality of levels of technology-based drawings wherein each level represents a distinct level of detail of communication equipment;
(b) providing a utility application that allows a user to search a master databases for products using search terms; and
(c) responding to user interaction to place a product symbol selected by a user in a level selected by the user.

8. A computer according to claim 2 further comprising a database for storing information about a plurality of communication products wherein the database is coupled to communicate with the drawing tool program, the estimation tool program and the specification tool program and exchange information with those programs as needed.

9. A computer according to claim 8 wherein the information about a plurality of communication products includes manufacturer and cost.

10. A method for testing communication equipment using a hand held tester, the method comprising steps of:
(a) specifying communication equipment for a structure using a drawing tool program;
(b) identifying each piece of communication equipment with a unique identification; and
(c) downloading the unique identification of step (b) to the hand-held tester.

11. A method for generating drawings, estimates and specifications for design of communication equipment in a structure, the method comprising steps of:
(a) searching a master database for a communication product using a utility application wherein a user enters search terms;
(b) selecting a product from the search conducted in step (a);
(c) inserting the product selected in step (b) in a computerized drawing;
(d) repeating steps (a)-(c) for as many products as needed; and
(e) comparing the products inserted in step (c) with a do not forget list.

12. The method of claim 11 further comprising a step (f) of generating a list of products forgotten resulting from step (e).

13. A method for generating drawings of a communication infrastructure, the method comprising the steps of,
(a) launching a drawing tool that designs floor plans;
(b) launching a CAD Tools that has access to all products saved in a master database;
(c) using the CAD Tools;
(d) selecting a product based on the search conducted in step (c); and
(e) transferring the product selected in step (d) to the floor plan.

14. The method of claim 13 wherein step (c) comprises searching by text string.

15. The method of claim 13 whereas step (c) comprises filling the search by manufacturer or category.

16. The method of claim 13 whereas step (e) comprises pasting the selected product onto a clipboard and pasting the product on the clipboard to the drawing.
